(19) United States
(12) Patent Application Publication
(10) Pub. No.: US 2013/0066972 A1
(43) Pub. Date: Mar. 14, 2013

(54) Recommendation and Matching Method and Systems

(71) Applicant: Justin McLeod, Washington, DC (US)

(72) Inventor: Justin McLeod, Washington, DC (US)

(73) Assignee: CLEOD9, INC., Washington, DC (US)

(21) Appl. No.: 13/609,395

(22) Filed: Sep. 11, 2012

Related U.S. Application Data
(60) Provisional application No. 61/533,516, filed on Sep. 12, 2011.

(51) Int. Cl. G06F 15/16

(52) U.S. Cl. 709/204

(57) ABSTRACT

The present invention includes methods and systems for matching people. Current methods of and systems for matching people fail to use the best source for gathering information about a person: others who know that person. The present invention uses crowd-sourced tagging to determine attributes of the population of potential recommendations. The invention can also determine a user's preferences either implicitly, by leveraging the user's ratings of others and the crowd-sourced tags to determine the most important attributes to the user, or explicitly, by allowing a user to specify the most important attributes of people.

### CROSS-REFERENCE TO RELATED APPLICATIONS

This application claims priority to U.S. Provisional Patent Application 61/533,516, which is hereby incorporated by reference.

### BACKGROUND OF THE INVENTION

1. Field of the Invention

The present invention relates to computer-implemented methods and systems for providing recommendations or matches to users based on a combination of crowd-sourced user tagging of familiar people and a user's preferences.

2. Description of Related Art

Current matching and recommendation algorithms tend to fall into one of three types: semantic search, collaborative filtering, and content-based filtering. Each type of algorithm has its advantages, but none is particularly well-suited to matching people, as in match-making applications.

In semantic search, the population of items is tagged with a set of attributes. The tagging is typically performed by the person adding the item to the population or the owner of the system. In a system for matching people, a person self-reports his or her own attributes. A user searches by specifying a desired set of attribute values. The system produces a result set of items with those attribute values. Traditional match-making sites work this way.

There are two major disadvantages to such systems. First, self-reported attribute tags are often inaccurate, either intentionally or inadvertently. Second, people typically cannot express what they like or why they like what they do. Current research shows that if asked directly what (or whom) they like, people will give the wrong answer. E.g., Daniel Kahneman, “Thinking, Fast and Slow,” Farrar, Straus, and Giroux (2011).

Collaborative filtering builds associations among items based on what people choose. Each item a user chooses is associated with each other item a user chooses, forming a network of associated items. When another user looks at one item, the system recommends other items based on the associations of other users to that item. For example, a collaborative filtering system might have gathered data showing that people who buy flashlights tend to also buy batteries, and recommend batteries to a user who is looking at a flashlight. Such systems work well for retail sites, like Amazon.com. These systems are not ideal for matching people, however, because they tend to default to popular choices; given that the supply of each person is exactly one, it is not practical to repeatedly recommend the same small group of people to others.

Content-based filtering combines some of the advantages of semantic searching and collaborative filtering. In a content-based filtering system, items in the population are tagged ahead of time. These tags may be determined by experts, provided by suppliers of the items, or developed using some other data source. For example, in a music system, items might be tagged based on what instruments are present, the gender of the singer, the volume, the genre, etc. When a user expresses a preference for an item (either explicitly or implicitly), the system recommends other items with similar attributes. Content-based filtering avoids the tendency of collaborative filtering to recommend the most popular items and generally does a better job of matching less popular items. The Pandora® music system uses this approach, and it works well for items with which an expert is familiar. Content-based filtering does not work well for matching people, however, because no expert can effectively tag people with whom he is unfamiliar, and no expert is familiar with a large enough proportion of the population to make this system practical for matching people.

Thus, it is desirable to have a system that can take the advantages of content-based filtering systems and apply them to the domain of matching people.

### BRIEF SUMMARY OF THE INVENTION

The present invention is a method and system for matching people with people, which may be based on romance, friendship status, recreational interests, or business relationships, for instance. The present invention typically divides data gathering into two parts or routines that can be run in parallel to perform the people matching activity.

In the first part, each user ranks the desirability of particular items on a simple scale in order to identify which items the user likes, dislikes, or is ambivalent about. To do this, two types of questions are used. In the first type of question, the user is presented with a picture of a person with whom she is familiar and asked to rank that person according to desirability. In the second type of question, the user is presented with several people with whom she is familiar and asked which one is most desirable. In some optional embodiments of the invention, a user is asked to identify attributes of people they deem important. In another optional embodiment, both approaches are combined; the user is asked the two types of questions described above and is also asked questions regarding which attributes that user deems important.

In the second part of data collection, all users tag certain attributes of people. In one type of question, for a particular attribute, a user is presented with several people with whom she is familiar and asked which one most closely possesses that attribute. In another type of question, a user is presented with one person with whom she is familiar and the possible attribute values in a category, and is asked which attribute the person possesses. Ideally, each person is tagged by a large number of others; in order to allow for some variation in tags, the system considers the majority response as a person's tagged attribute in that category. This combination of crowd-sourcing and ensuring some level of familiarity with people being tagged helps increase the accuracy of the attribute tagging.

Optionally, questions related to both parts of the data-gathering process can be interleaved. This may increase user engagement in the data-gathering process.

Once the attribute data is gathered, crowd-sourced tagged attributes for people are combined with a user's ratings to determine which attributes are most important to that user. For each person the user rated, that person's attributes are used to calculate a preference with respect to each attribute. For example, in a matchmaking system, if every person the user expressed attraction for is rated as spontaneous, the user would be identified as having a preference for spontaneous people. The user's preferences for attributes are then ranked in order of strength, i.e., consistency of the presence of those attributes in people the user has rated.

Recommendations are made using people who are not known to a user. One way to create this population of recommendations is to start with people who are connected to the user's direct connections. For example, if the present invention were used in combination with the social networking site Facebook®, the initial set of people would be friends of a user's friends.

For each person included in the initial data set, a recommendation score is computed using one or more of several components. In a typical embodiment, three components are used: compatibility of attributes with preferences (or “fit”), compatibility of desirability, and relevance.

The fit component is computed by comparing a user's preferences (determined as described above) to a person's attributes (tagged by the crowd-sourcing method). Attributes for which the user has a stronger preference are weighted more heavily in computing the fit score.

The personal desirability score of each person is computed by recording how many other users rated the person as desirable. This computation is performed during the data gathering described above. In making a recommendation, the desirability component is computed by comparing the personal desirability score of the user with a person in a potential set of matches. The desirability component is designed to increase the overall recommendation score if the person and the user have complementary levels of desirability.

The relevance component includes ensuring that sexuality of the user and the potential match are compatible; ages are not too far apart; geography is not too far apart; the candidate is the correct gender; and that both people are available for matching. These relevance factors may be exclusionary in the sense that a candidate is completely removed from the list if they fail to satisfy one or more of them. This would be the case if the user is straight and the potential match is gay. Other relevance components may add or lower the recommendation score. For example, someone local would be rated as more relevant than someone across the country, but might not be completely removed from the set of recommendations. The relevance factor does not exclude people based on unknown information (or holes in the data). Using the example of locality, if a person has an unknown location, that fact would neither increase nor reduce the candidate's recommendation score, it simply would not factor into the relevance component of the score. As another example, if a match candidate has expressed interest in the user (as described below), that person's recommendation score would be increased.

After computing scores that indicate likely compatibility between users in a matchmaking system, several candidates can be presented to a user. If the user expresses an interest in one or more of those candidates, that interest can be noted in the system and used for refining or redefining the match set. In a method that involves matching people, if both users show a mutual interest, they can optionally be given the option of contacting each other.

This method may be implemented in a client-server system, preferably based on the World Wide Web. In such an embodiment, users interact with the system through web pages accessible through a browser on a client, which communicates with back-end servers. The back-end servers contain the logic needed to generate recommendations or matches, which are then presented to a user through a web browser. Attribute and ratings data are stored in description database that may be hosted on the back-end servers or on a separate, but connected, database server.

Client devices, including desktop and portable PCs, mobile devices, and tablets, communicate with the system over a communications network. The communications network may comprise any network or combination of networks, including the Internet, a local area network, a wide area network, a wireless network, and a cellular network.

### BRIEF DESCRIPTION OF THE SEVERAL VIEWS OF THE DRAWINGS

FIG. 1 shows a method of gathering data for use in later matching.

FIG. 2 illustrates an example of tagging people.

FIG. 3 illustrates another example of tagging people.

FIG. 4 shows an exemplary hardware embodiment of the system.

FIG. 5 illustrates an example of rating people.

FIG. 6 illustrates another example of rating people.

FIG. 7 illustrates an example embodiment involving creation of a set of potential recommendations.

### DETAILED DESCRIPTION OF THE INVENTION

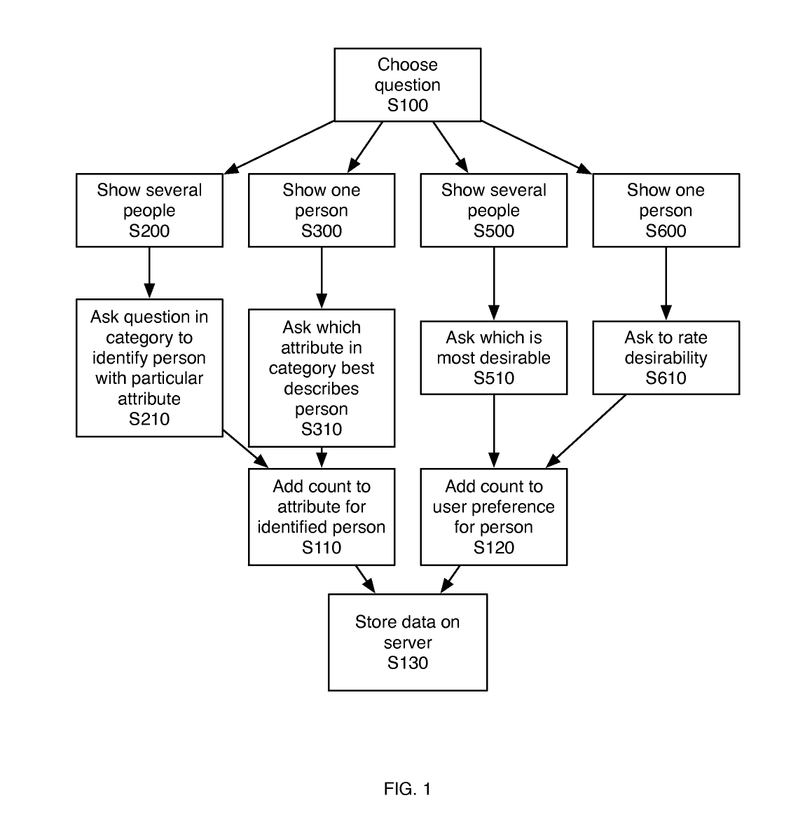

FIG. 1 illustrates the data-gathering technique of the invention. A question is chosen in step S100. The rest of the steps of the matching method are set forth below:

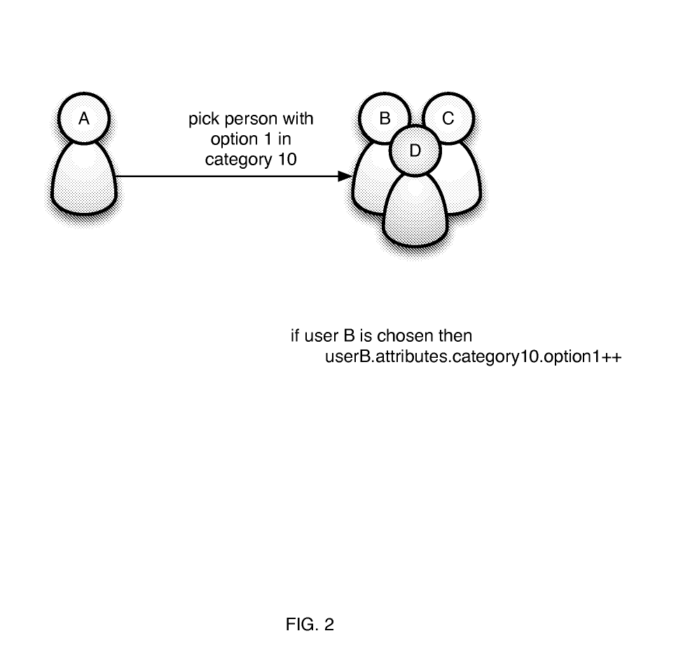

1. Tagging: There are two approaches to tagging people presented in the described embodiment of the method. First, in step S200 a user is shown several people (each with a unique ID) that the user knows or is familiar with. In step S210, the user is asked a question about that group of items, picked from a discrete set of questions, where each question corresponds to some “dimension” of those items (physical or personal) and where there are discrete sets of responses from which the user can choose. Each response corresponds to some “attribute” within that dimension. The user is asked to identify the person that possesses the attribute to the highest degree. The person's attribute count is incremented, as shown in step S110. This process is repeated, with different items and different questions. FIG. 2 illustrates this approach graphically.

The people being tagged (and rated as described below) may be other users of the system, but that is not required. In a typical embodiment, the system leverages an existing social network, such as Facebook® or LinkedIn®. Accordingly, any person linked to a user through the social network may be presented for rating and/or tagging.

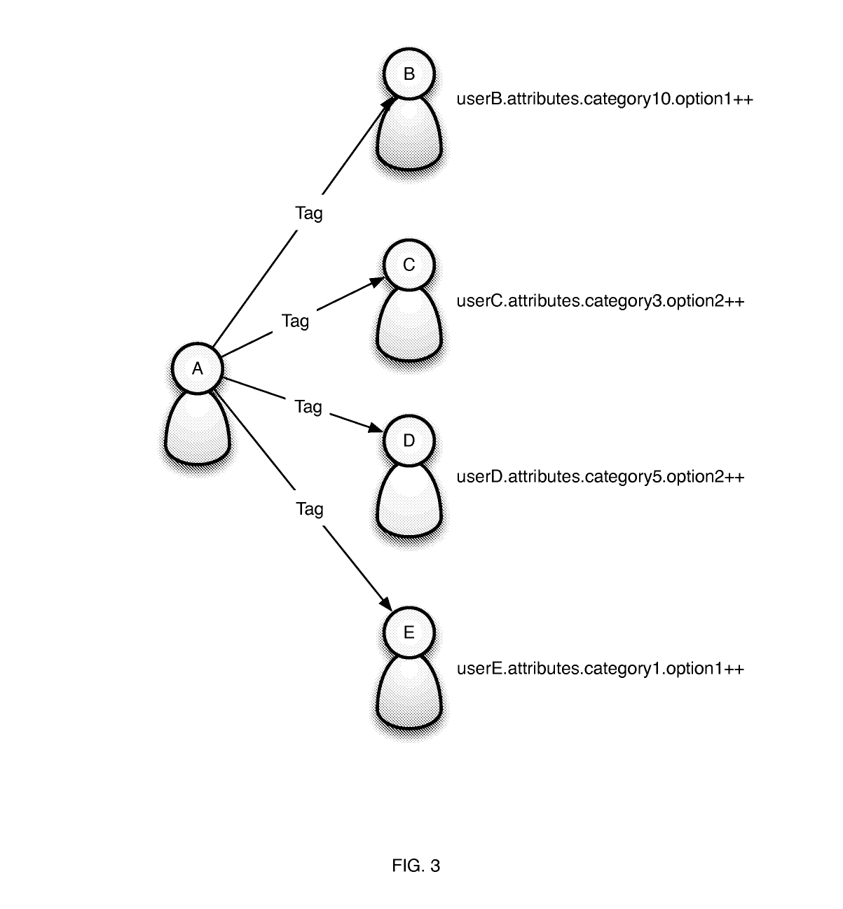

The second approach is shown in step S300—to present a single person that the user knows or is familiar with along with the possible attribute values for a particular category. In step S310, the user is asked which attribute best describes the person. The person's attribute count is incremented, as shown in step S110. FIG. 3 illustrates this second approach graphically.

In step S130, the data generated from the user's answers is transmitted and stored on one or more servers.

2. Concatenation: All tags for each person are consolidated according to the person's unique ID. For each dimension (question), a “leading” attribute (response) is determined, based on the most popular/recent response given for that person within that dimension.

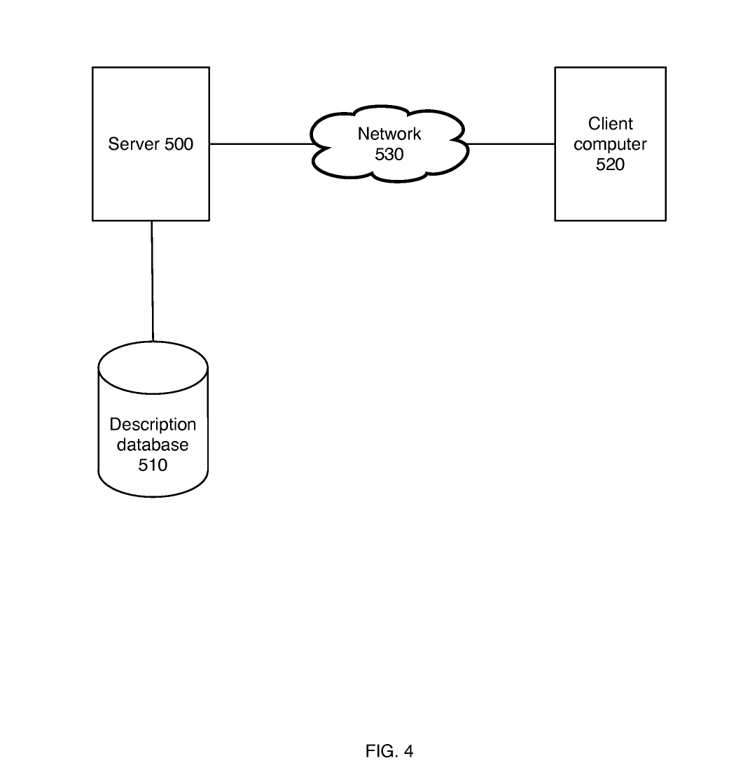

3. Description Database: All the concatenated data is stored on one or more connected servers in a description database. FIG. 4 shows a typical hardware embodiment of the present invention. A server 500 is connected to a description database 510. Server 500 may also be implemented as a server cluster or other configuration of multiple servers known in the art. A client computer 520 connects to the server 500 using network 530. Network 530 may be any standard computer network known in the art, such as the Internet, LAN, WAN, mobile network, satellite network, or other network, including a combination of such networks.

4. User Ratings: A user is shown a person (each with a unique ID) that the user knows or is familiar with. The user rates people in one of two ways.

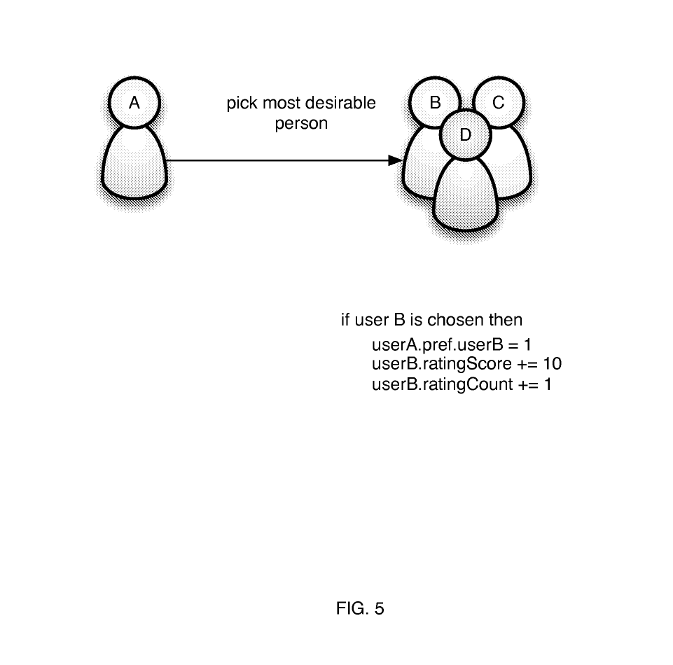

In step S500 of FIG. 1, a user may be given a group of several people that she knows and in step S510, be asked to choose the most desirable person in the group. A graphical example is shown in FIG. 5. In this example, User A has chosen User B as most desirable from among Users B, C, and D. User A's preference for B is noted. User B's total rating score is increased in step S120 of FIG. 1, and the count of people who have chosen User B is incremented.

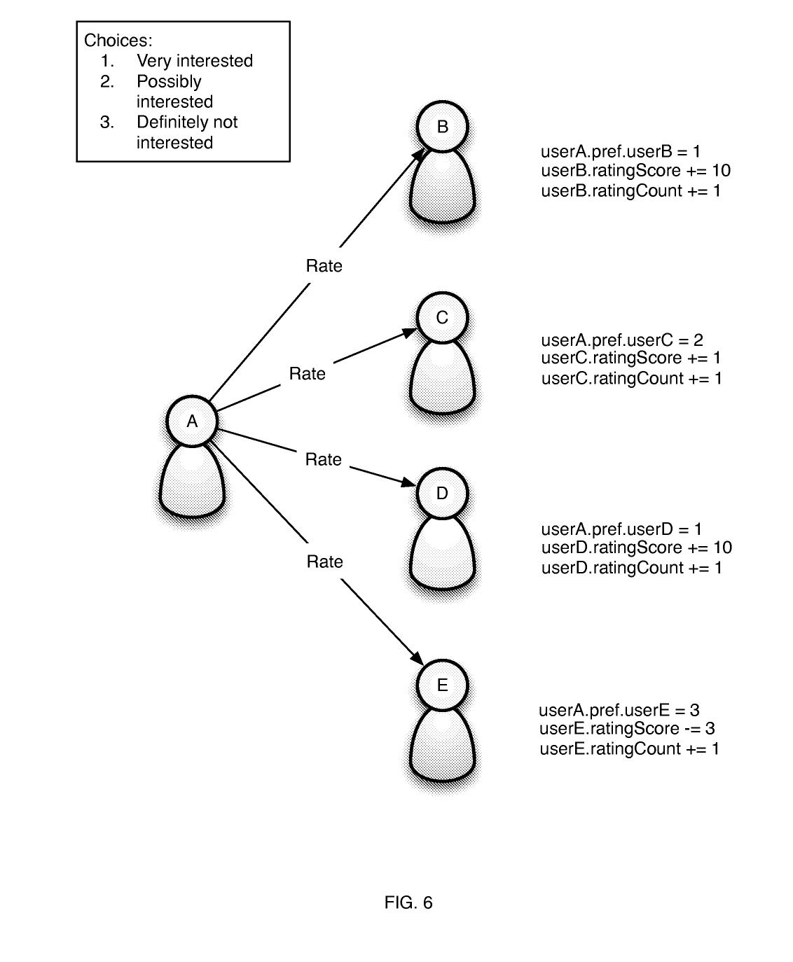

Steps S600-S610 of FIG. 1 show another type of question that may be asked. In step S600, the user is shown a single person; in step S610, the user is asked to rate the person's desirability. A graphical example is shown in FIG. 6. In this example, User A is shown Users B, C, D, and E individually and asked, for each user, if that person is desirable. The user is asked to rate that person according to personal tastes, picking from a discrete set of possible responses. As shown in FIG. 6 and in step S120 in FIG. 1, User A's preferences for each person are recorded. For each user, User A's responses are used to adjust that user's ratings accordingly. For example, User A has rated User E with the lowest rating. User E's rating score is decremented as a result.

The user rating processes described above are repeated, with different people. This data is transmitted and stored on one or more connected servers in step S130 of FIG. 1. Optionally, questions regarding tastes and ratings can be interleaved and presented to the user in any order.

5. User Tastes: A user's ratings are combined with the description database to determine which attributes the user prefers. Looking at each person the user rated, the system learns which attributes the user prefers and which the user doesn't prefer. In a typical embodiment, for each category of attributes, the system identifies which attribute in the category has the highest score (assuming one exists). That attribute is the “leading” attribute for the category.

Specifically, a score is generated for each attribute within each category. As the system considers each person the user rated, it looks at that person's attributes and then updates the user's taste profile by modifying that attribute score. For example, in a matchmaking system, if a user expresses attraction to a person with an attribute of “spontaneous,” points would be added to the user's bucket for the “spontaneous” attribute. Conversely, points are subtracted when a user says a person they rated is undesirable.

The present invention also typically considers consistency versus inconsistency. For example, if the user always likes spontaneous people and never likes planners, that preference is important and is heavily weighted when factored into the score. If the user sometimes likes religious people and sometimes likes atheists, that preference is not important and that factor is given less weight.

In a typical embodiment, analysis of consistency is performed by comparing scores among attributes within each category. Those categories with the largest difference in scores among attributes are considered most important to the user and therefore ranked highest; while those with lower differentials are ranked lowest. The fit score (described below) then accounts for these rankings when determining compatibility.

For example, if there are 10 categories of attributes, each category is given a rank from 1 to 10, with 1 being the highest rank. In this way, attributes for which the user has the strongest preference are ranked highest. This is one such way of combining ratings and descriptions to determine user tastes; other alternatives include multivariate analysis, regression analysis, or other types of algebraic or statistical trending computations.

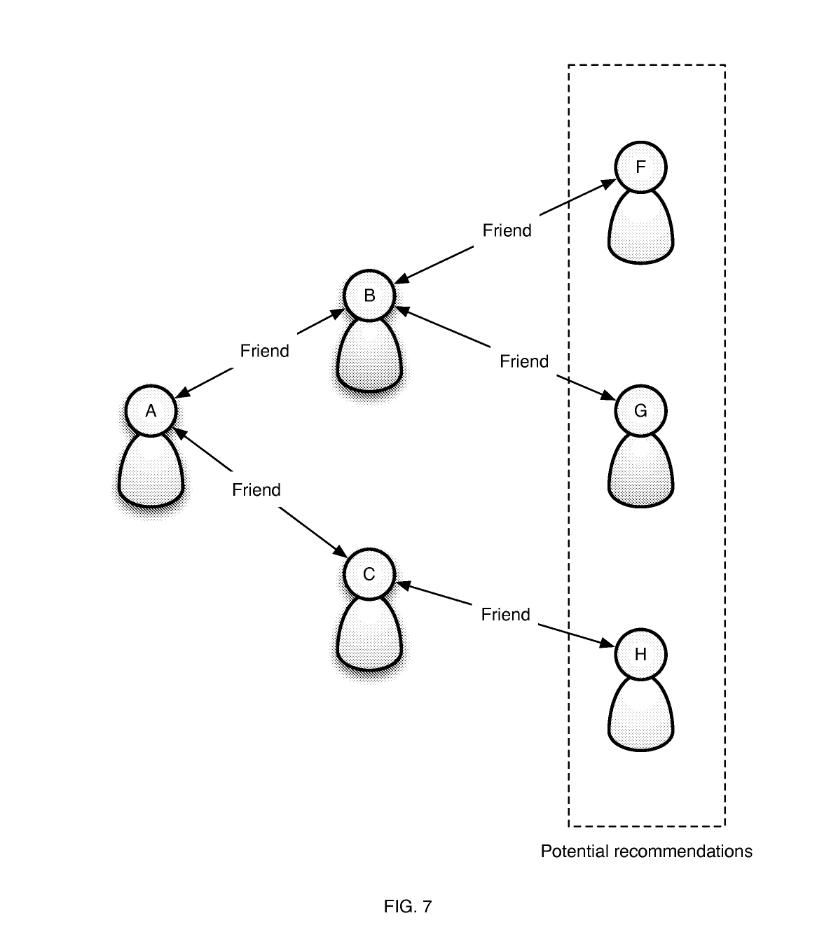

6. User Recommendations: The system starts with a population of people as potential recommendations for a User A. The initial set of potential recommendations may be generated in a variety of ways. In a typical embodiment, the initial set of potential recommendations is a subset of users. If the users are members of a social network, the initial set of potential recommendations might be created using the set of users who are two connections away from User A. An example based on the “friend” relationship is shown in FIG. 7. User A is friends with Users B and C. Users F, G, and H are two connections away from User A, so they would be in the initial set of potential recommendations.

For each person in the set of potential recommendations, a recommendation score is computed. As noted above, the recommendation score typically comprises several components: a “fit” score, a general desirability score, and a relevance factor.

The fit score specific to the user is computed based on the correlation between the leading attributes for each person and the leading “tastes” for the user. Higher-ranking attributes are given more weight than lower-ranked attributes in determining the compatibility score between a user and persons being ranked. For example, if there are 10 categories of attributes, those categories have a ranking from 1 to 10, as described above. With such a ranking, the fit score could be computed by the equation,

$${Σ}_{c ∈ C} {comp}_{C} ( u , p , c )$$

$${comp}_{C} ( u , p , c ) = \{ \begin{matrix}( \vert C \vert - rank ( c ) ) , & {u}_{{c}_{pref}} = {p}_{{c}_{lead}} \\ - ( \vert C \vert - rank ( c ) ) \text{/} 3 , & otherwise\end{matrix}$$

where C is the set of categories and comp_{C} computes the compatibility score between user u and person p with respect to category c. The rank function returns the ranking of a category of attributes, u_{cpref} is the user's preferred attribute in category c, and p_{c}_{_{lead}} is the potential recommendation's leading attribute in category c. That is, the compatibility score in a category is positive if the user's preference in a category matches the person's attribute in that category and negative otherwise. Because the magnitude of the compatibility score for a category is higher for higher ranked categories, matches (or mismatches) in the most important attributes will have more effect than matches (or mismatches) in less important attributes. The ranking is from 1 to the size of the set of categories. Other ways of computing the fit score are also possible, as would be understood by one of ordinary skill in the art.

The desirability score is based on how frequently a person in the potential recommendation set has been rated highly by other users. As described above, when a person is rated by a user, the person's desirability rating and count of times rated are updated. A personal desirability score for the person may be computed by, for example, dividing the total of all ratings by the maximum possible score the person might have gotten given the number of times he was rated. This produces a number between 0 and 1. The user has a personal desirability score computed in the same way.

In terms of computing the recommendation score, a person with a personal desirability score that is higher, but not too much higher, than the user is given the maximum desirability score. An example of an equation that produces such a result is for a user u and a person p,

1−(|desₚ(u)−desₚ(p))|·2)

where the desₚ function returns the personal desirability score of a person. Other equations are also possible. For example, if a person has a lower desirability score than the user, that might affect the recommendation score more negatively than a person with a higher desirability score than the user, even if the absolute values of the difference between the person's score and the user's score are the same. Such an equation might look like,

$$des ( x ) = \{ \begin{matrix}1 - ( ( {des}_{p} ( p ) - {des}_{p} ( u ) ) \cdot 2 ) , & {des}_{p} ( p ) > {des}_{p} ( u ) \\ 1 - ( ( {des}_{p} ( u ) - {des}_{p} ( p ) ) \cdot 6 ) , & {des}_{p} ( u ) \geq {des}_{p} ( p )\end{matrix}$$

where des is the desirability score function.

The relevance factor operates in one of two ways. First, it looks at factors that may require completely removing a person from the potential recommendation set. For example, in a matchmaking system, if a person is known to have a sexuality preference that is incompatible with the user, that person is removed from the potential recommendation set. As another example, if the age gap between the user and the person is too large (e.g., 30 years or more), the person is removed from the potential recommendation set. As a further example, in a matchmaking system, if a person is not single or is not the appropriate gender, that person would be removed from the potential recommendation set.

The other way the relevance factor works is to adjust the total recommendation score based on factors that make the person more or less relevant. For example, a local person is more relevant than one who is across the country. A person located at a great distance from the user might still be a worthwhile match, however, so rather than removing the person completely, the relevance score is simply lower for that person than it is for people geographically closer. As another example, a person is potentially more relevant if he or she has many connections in common with the user. In this example, the relevance factor would adjust the recommendation score depending on the number of connections the user has in common with the potential recommendation. If data is missing (for example, if a person's location is unknown) that factor would not be used to remove a person. The relevance factor typically makes adjustments based on a number of different factors such as those described above.

Recommendations are then communicated to the user. “Scoring” the recommendations that are delivered to a user is one option. The filter could also operate using a threshold score; people scoring above the threshold are recommended, while everyone else is excluded.

The interface presenting these recommendations to the user allows the user to express interest or lack of interest in each one. If two users of the system express interest in each other, the system can notify both of them using standard communication techniques, such as email, text messages, or messaging through a social network.

Typical matching systems limit recommendations to members of the system. The present invention, however, is not so limited. As described above, the people being tagged and/or rated are typically taken from a user's connections on an existing external social network, such as Facebook® or LinkedIn®.

If a registered user expresses interest in someone who is not registered with the system, the user is optionally presented with the opportunity to invite that person into the system, either personally or anonymously. In this way, the system of the invention can grow its pool of users organically.

While the invention method has been described using items that are people seeking a romantic relationship, it can also be applied to people seeking professional relationships or people seeking general social relationships with other compatible people or people with similar backgrounds and interests. It could also be used to match, for example, potential renters with landlords.

The matching methods described above may be implemented in software, hardware, firmware, or any combination thereof. The methods are preferably implemented using one or more computer programs executing on a programmable computer (which can be part of the server computer system) including a processor, a storage medium readable by the processor (including, e.g., volatile and non-volatile memory and/or storage elements), and input and output devices. Each computer program can be a set of instructions (program code) in a code module resident in the random access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described several illustrative embodiments of the present invention, it is to be appreciated that various alterations, modifications, and improvements will readily occur to those skilled in the art. Such alterations, modifications, and improvements are intended to form a part of the teachings of this disclosure, and are within the spirit and scope of this disclosure of the invention. While some embodiments and examples involve specific combinations of functions or structural elements, it should be understood that those functions and elements may be combined in other ways according to the present disclosure to accomplish the same or different objectives. In particular, acts, elements, and features discussed in connection with one embodiment are not excluded from similar or other appropriate roles in other embodiments.

Additionally, elements and components described herein may be further divided into additional components or joined together to form fewer components that perform the same described functions. For example, the computer server system may comprise one or more physical machines, or virtual machines running on one or more physical machines. In addition, the computer server system may comprise a cluster of computers or numerous distributed computers that are connected by the Internet or another public or private network.

Finally, the description and drawings are examples and embodiments only, and are not intended to limit the scope of the present invention to their literal teachings.

1. A computer-implemented method for recommending people to a user comprising:
a. providing a plurality of categories, where each category comprises a plurality of attributes;
b. providing the user with a plurality of computer-implemented tagging questions, wherein each tagging question asks the user to tag a person with whom the user is familiar with an attribute from a category;
c. storing the tagged attributes in a tags database;
d. determining a set of attribute preferences for the user;
e. creating a set of potential recommendations for the user, wherein the set of potential recommendations comprises other people;
f. for each person in the set of potential recommendations, assigning a compatibility score to the person; and
g. providing a set of recommendations comprising one or more people to the user.

2. The method of claim 1, where the tagging questions comprise either selecting an attribute from a category that best describes the person or selecting a person from a plurality of persons who best fits an attribute from a category.

3. The method of claim 1, further comprising for each person in the tags database, for each category, determining the lead personal attribute, where the lead personal attribute is the attribute in the category with which the person was most frequently tagged.

4. The method of claim 1, where determining a set of attribute preferences comprises allowing a user to specify, for each category, which attribute the user prefers.

5. The method of claim 3, further comprising:
a. providing the user with a plurality of computer-implemented rating questions, wherein each rating question asks the user to rate a person with whom the user is familiar; and
b. storing the ratings in a ratings database on a computer.

6. The method of claim 5, where determining a set of attribute preferences comprises determining, for each category, the lead preferred attribute, where the lead preferred attribute is the lead personal attribute in the category most commonly possessed by people the user rated highly.

7. The method of claim 6, where determining a set of attribute preferences further comprises ranking the plurality of categories based on the consistency of the match between the lead preferred attribute and the lead personal attribute among people the user rated highly.

8. The method of claim 7, further comprising assignment of a compatibility score to a person in the set of potential recommendations, which is calculated based on at least a fit score and a desirability score.

9. The method of claim 8, where assigning a compatibility score comprises removing people from the set of potential recommendations based on relevance factors.

10. The method of claim 9, where assigning a compatibility score further comprises adjusting the compatibility score based on relevance factors.

11. The method of claim 1, where providing a plurality of computer-implemented tagging questions further comprises allowing the user to select people to tag with a specified attribute.

12. The method of claim 1, where the tagging questions comprise sorting a group of people according to how strongly each person in the group possesses a specified attribute.

13. The method of claim 1, further comprising allowing the user to choose one or more people with whom the user is familiar and providing the user with tagging questions for the one or more people.

14. The method of claim 3, further comprising allowing the user to search for people based on the values of one or more personal lead attributes.

15. A system for matching people comprising:
a computer network;
a plurality of users;
a description database; and
at least one computer server, wherein the at least one computer server is configured to perform operations comprising:
a. providing a plurality of categories, where each category comprises a plurality of attributes;
b. providing the user with a plurality of computer-implemented tagging questions, wherein each tagging question asks the user to tag a person with whom the user is familiar with an attribute from a category;
c. storing the tagged attributes in a tags database;
d. determining a set of attribute preferences for the user;
e. creating a set of potential recommendations for the user, wherein the set of potential recommendations comprises other people;
f. for each person in the set of potential recommendations, assigning a compatibility score to the person; and
g. providing a set of recommendations comprising one or more people to the user.

16. The system of claim 15, where the at least one computer server is further configured to perform operations comprising:
a. providing the user with a plurality of computer-implemented rating questions, wherein each rating question asks the user to rate a person with whom the user is familiar; and
b. storing the ratings in a ratings database on a computer.
